(19) United States
(12) Patent Application Publication
(10) Pub. No.: US 2015/0039495 A1
(43) Pub. Date: Feb. 5, 2015

(54) STORAGE BATTERY CONTROL METHOD AND STORAGE BATTERY CONTROL SYSTEM

(71) Applicant: Panasonic Corporation, Osaka (JP)

(72) Inventors: Akito Fukui, Kanagawa (JP); Hideaki Kongouji, Tokyo (JP); Haruyuki Ishio, Shiga (JP)

(21) Appl. No.: 14/374,662

(22) PCT Filed: Nov. 26, 2013
(86) PCT No.: PCT/JP2013/006934

§ 371 Date: Jul. 25, 2014

(30) Foreign Application Priority Data
Nov. 26, 2012 (JP) 2012-257936

(51) Int. Cl. H02J 3/32; G06Q 50/06; G06Q 20/10

(52) U.S. Cl. CPC H02J 3/32; G06Q 20/10; G06Q 50/06
USPC 705/39; 307/31; 307/24

(57) ABSTRACT

A storage battery control method used by a control device controlling a storage battery prepared for a plurality of consumers, and involves detecting an amount of power used by each of the consumers per unit time, making a judgement regarding whether or not the amount of power used by one or more of the consumers exceeds a threshold determined in advance, and when the judgement finds that the amount of power used by the consumers exceeds the threshold, supplying electric power from the storage battery to a distribution system to which the one or more consumers belong.

### TECHNICAL FIELD

The present disclosure pertains to a control system for a large-capacity battery.

### BACKGROUND ART

In recent years, homes have increasingly been provided with an emergency power supply in preparation for power outages, disasters, and so on.

This is not limited to houses, as condominiums and the like are also provided with an emergency power supply in the form of a large-capacity battery for each collective housing building.

Patent Literature 1 discloses a power supply system performing control of electric power when emergency power is supplied to collective housing.

### CITATION LIST

### Patent Literature

[Patent Literature 1]
Japanese Unexamined Patent Application Publication No. 2011-205871

[Patent Literature 2]
Japanese Unexamined Patent Application Publication No. 2012-191825

### SUMMARY OF INVENTION

### Technical Problem

The present disclosure pertains to a storage battery control method that enables the user-friendliness of batteries to be enhanced when a large-capacity battery is supplied to multiple households.

### Solution to Problem

In order to solve the above-described problem, the present disclosure provides a storage battery control method used by a control device controlling a storage battery prepared for a plurality of consumers, the storage battery control method involving: detecting an amount of power used by each of the consumers per unit time; making a judgement regarding whether or not the amount of power used by one or more of the consumers exceeds a threshold determined in advance; and when the amount of power used by the consumers exceeds the threshold, supplying electric power from the storage battery to a power distribution system to which the one or more consumers belong.

### Advantageous Effects of Invention

According to the above configuration, a peak cut of electric power is executable for a given consumer. For example, in a scheme such as high-voltage collective reception where power fees are determined according to peak usage, this configuration enables a reduction in fees to be paid.

### BRIEF DESCRIPTION OF DRAWINGS

FIG. 1 is a system diagram indicating the configuration of a storage battery control system.

FIG. 2 is a block diagram illustrating the functional configuration of an aggregator 100.

FIG. 3 is a block diagram illustrating the configuration of a condominium 120a.

FIG. 4 is a block diagram illustrating the functional configuration of a mega-battery 110.

FIG. 5 is a schematic diagram of a data configuration for a power control table 201.

FIG. 6 is a schematic diagram of a data configuration for a remaining power table 202.

FIG. 7 is a flowchart indicating operations of the battery control system pertaining to Embodiment 1.

FIG. 8 is a continuation of FIG. 7.

FIG. 9 is a flowchart indicating operations of the aggregator 100 performing an incentive process.

FIG. 10 is a flowchart indicating operations of the aggregator 100 pertaining to Embodiment 2.

FIG. 11 is a continuation of FIG. 10.

FIG. 12 is a system diagram indicating the configuration of a storage battery control system pertaining to Embodiment 3.

FIG. 13 is a block diagram illustrating the functional configuration of a control server.

FIG. 14 is a chart indicating usable power for different communities in respective time slots.

FIG. 15 is a flowchart indicating operations of the storage battery control system pertaining to Embodiment 3.

### DESCRIPTION OF EMBODIMENTS

### (Discovery by Inventors)

Ownership of mega-batteries is currently increasing among collective housing such as condominiums and apartment buildings. The approach in which a plurality of such buildings share a common mega-battery seems likely to increase from now on.

As it happens, low-voltage reception and high-voltage collective reception schemes are used as services for receiving commercial power supplied by a power company. In a low-voltage reception scheme, each household individually receives low-voltage power supplied by the power company. In a high-voltage collective reception scheme, high-voltage power is supplied at once to a group. This scheme is commonly used for collective housing, such as condominiums. Given that high-voltage power is received at once in the high-voltage collective reception scheme, there is a need to reduce the voltage and distribute the power to discrete units of the condominium or similar, but the basic cost is lower than that of the low-voltage reception scheme.

Conversely, in the high-voltage collective reception scheme, electricity fees are often increased once per month according to power consumption that approaches or exceeds a peak (e.g., a number of times the peak is reached, an amount of power consumed at the peak, or similar). Thus, a constraint on the occurrence of peaks is desired in order to reduce electricity fees.

The inventors arrived at one such approach in which a mega-battery is shared among a plurality of collective housing units, such as condominiums, in order to realise a peak cut.

A storage battery control system pertaining to the disclosure is described below.

### Embodiment 1

The following describes a storage battery control system of the disclosure, with reference to the accompanying drawings.

### (Configuration)

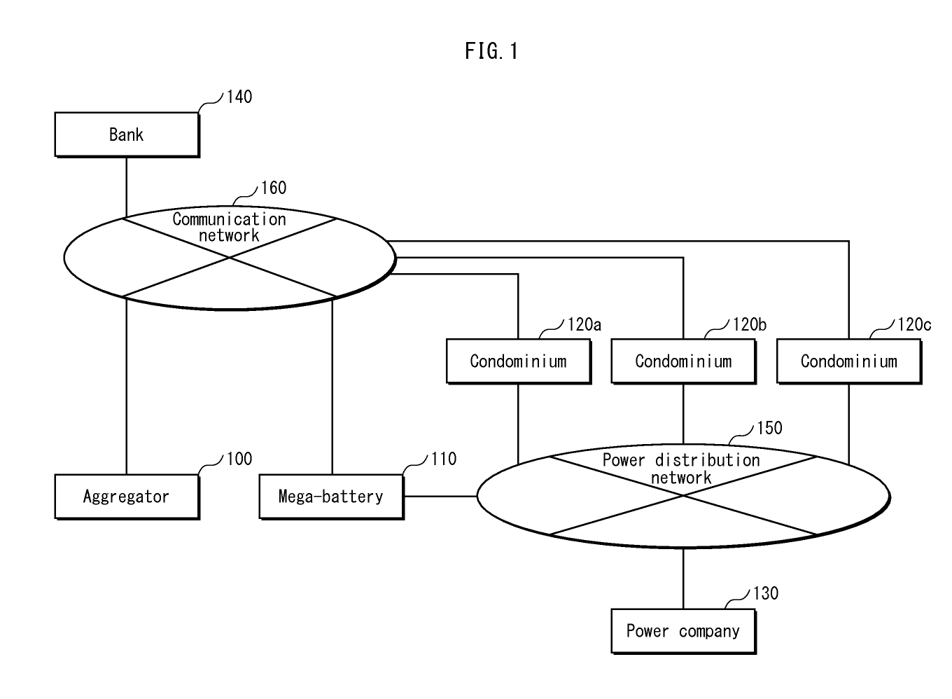

FIG. 1 is a system diagram indicating the configuration of the storage battery control system.

As shown, the storage battery control system includes an aggregator 100, a mega-battery 110, condominiums 120a, 120b, and 120c, a power company 130, a bank 140, a power distribution system 150, and a communication network 160.

The aggregator 100 is connected, via the communication network 160, to the mega-battery 110, the condominiums 120a, 120b, and 120c (more accurately, to a common controller for each condominium building, as described later), and to the bank 140.

The mega-battery 110 is a large-capacity battery connected to the aggregator 100 via the communication network 160. The mega-battery 110 is also connected to the power distribution system 150, discharges to the power distribution system 150, and charges from the power distribution system 150.

The condominiums 120a, 120b, and 120c are each connected to the aggregator 100 via the communication network 160. The condominiums 120a, 120b, and 120c each receive commercial power supplied from the power company 130 via the power distribution system 150, and the commercial power is in turn supplied to various electric appliances in rooms of the condominiums. Here, the condominiums 120a, 120b, and 120c collectively receive electric power supplied from the power company through a high-voltage collective reception scheme.

The power company 130 supplies the commercial power to the condominiums 120a, 120b, and 120c via the power distribution system 150.

The aggregator 100 is described in detail below.

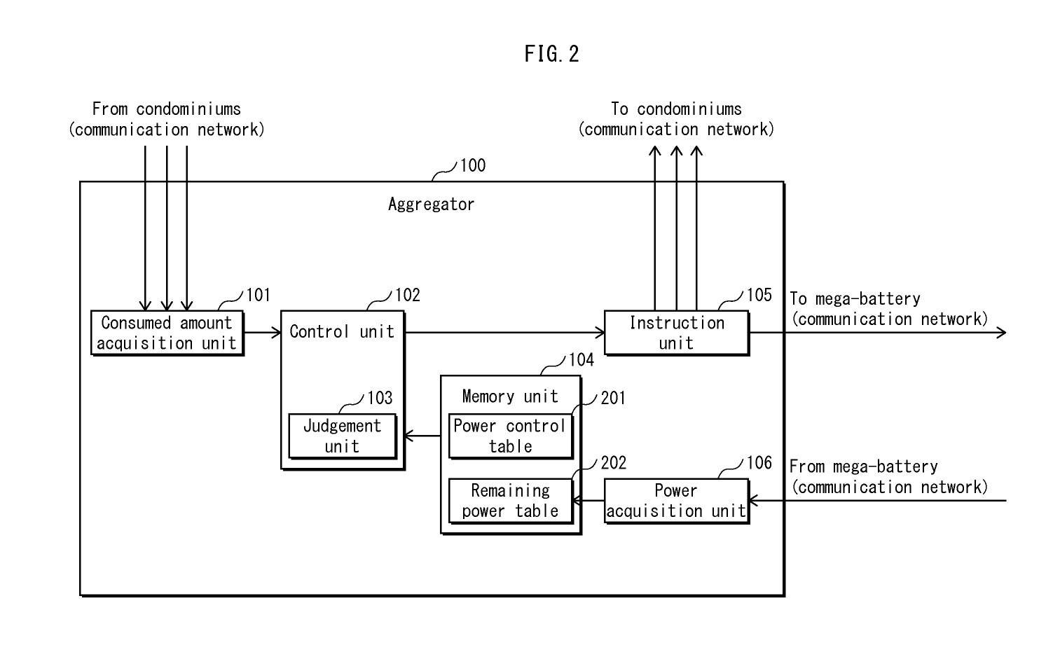

FIG. 2 is a block diagram illustrating the functional configuration of the aggregator 100.

As shown, the aggregator 100 includes a consumed amount acquisition unit 101, a control unit 102, a memory unit 104, an instruction unit 105, and a power acquisition unit 106.

The consumed amount acquisition unit 101 is connected to the communication network 160 and to the condominiums 120a, 120b, and 120c, and serves to acquire a consumed amount from each of these. The consumed amount is associated with a condominium ID that indicates one of the condominiums in order to distinguish the consumed amount for each condominium, and is then transmitted. The consumed amount acquisition unit 101 acquires the consumed amount transmitted by each condominium at a regular interval (e.g., once per minute), and transfers the consumed amount acquired for each condominium to the control unit 102.

The control unit 102 includes a judgement unit 103, controls the functions of the aggregator 100, performs a judgement process of judging whether or not discharge of the mega-battery 110 is needed, and performs a battery control process of controlling discharge of the mega-battery 110.

Upon receiving the consumed amount for each condominium from the consumed amount acquisition unit 101, the control unit 102 transfers the consumed amounts to the judgement unit 103.

The judgement unit 103 makes a judgement regarding whether or not a total consumed amount exceeds a predetermined threshold (hereinafter termed a total power threshold), based on the consumed amount transferred for each condominium. Specifically, the judgement unit 103 sums the respective consumed amount transferred from the condominiums 120a, 120b, and 120c to obtain the total consumed amount. Next, the judgement unit 103 references a power control table 201 stored in the memory unit 104 and calculates the total power threshold as a sum of respective power thresholds set for each condominium. The judgement unit 103 then judges whether or not the total consumed amount exceeds the total power threshold.

When the total consumed amount exceeds the total power threshold, the judgement unit 103 references the power control table 201 to make a further judgement regarding whether or not the respective consumed amount of each condominium exceeds the power threshold set for the condominium. The judgement unit 103 transfers information indicating that the total consumed amount has exceeded the total power threshold, and information (i.e., a condominium ID) for the condominium with a consumed amount that exceeds the power threshold to the control unit 102.

Upon receiving a notification from the judgement unit 103 indicating that the total consumed amount exceeds the total power threshold, the control unit 102 performs the battery control process to reduce the consumed amount (i.e., performs a peak cut) of the condominium having a consumed amount that exceeds the power threshold.

The battery control process involves the control unit 102 referencing a remaining power table 202 for the condominium judged by the judgement unit 103 to have exceeded the power threshold, and transmitting an instruction to the instruction unit 105 such that a power cell of that condominium is to be discharged. However, when a sum of the remaining power in the power cell and the power threshold is less than the consumed amount, the power control table 201 is referenced to transfer, to the instruction unit 105, one of a discharge instruction to a power cell of another one of the condominium, a discharge instruction to a sub-battery when the condominium is equipped with a sub-battery, and a request instruction for consumed power constraint control by a home energy management system (hereinafter, HEMS) when the condominium is registered with a HEMS.

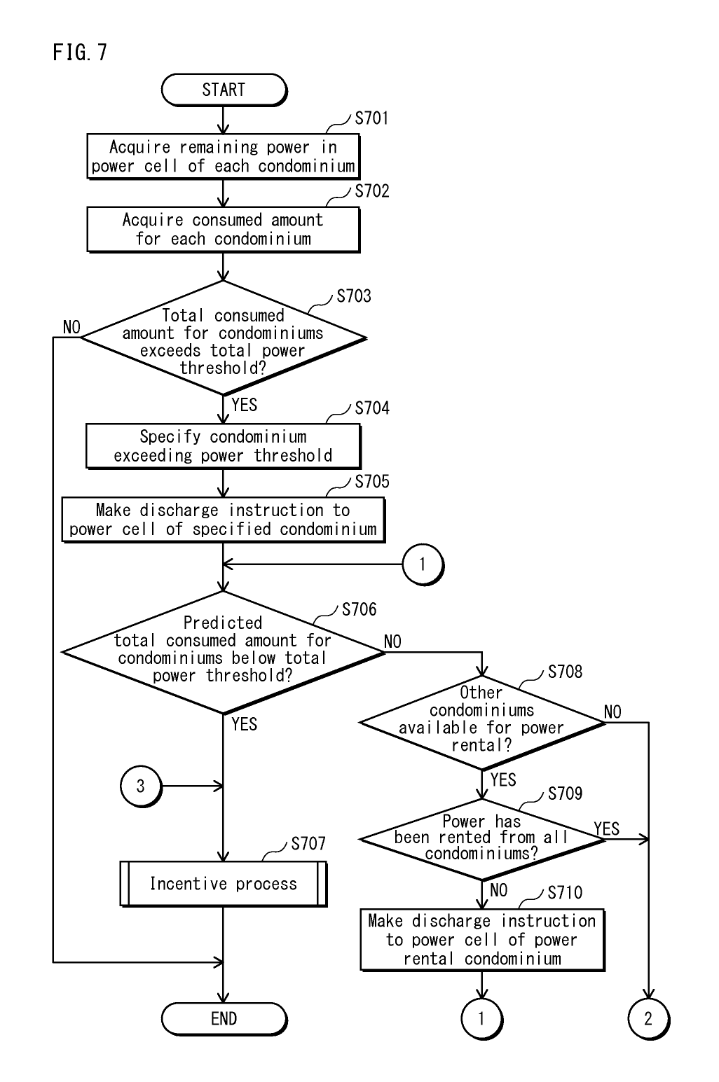

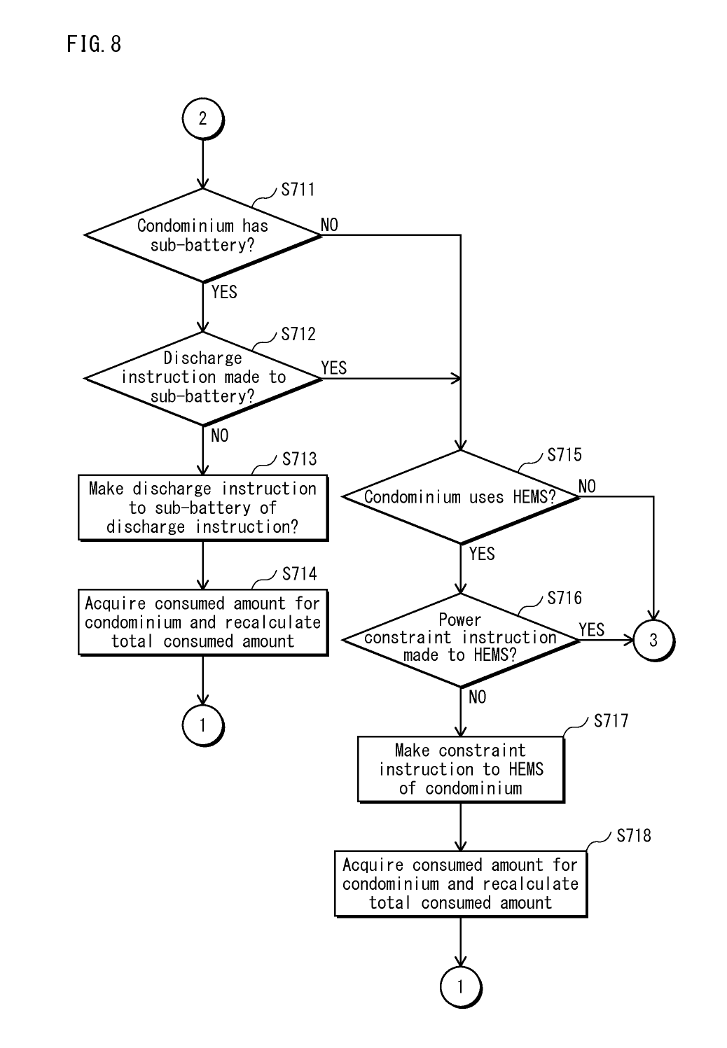

The details of the battery control process are described later, with reference to the flowcharts of FIGS. 7 and 8.

Also, when discharge from the mega-battery 110 is required for the peak cut and power has been borrowed from another condominium, the control unit 102 performs an incentive process of having the condominium pay an incentive to the other condominium. The incentive is paid out as money. Here, a predetermined fee calculation formula (e.g., calculating a product V×P of an amount of power borrowed per unit time V and a price per unit time P) is applied in accordance with the amount of borrowed power. The control unit 102 then makes a request from the instruction unit 105 to the bank 140, via the communication network 160, to have the amount of the calculated incentive transferred from an account of the power-borrowing condominium to an account of the power-second threshold condominium.

The memory unit 104 stores programs and data required for operating the aggregator 100, and is realised as a recording medium such as a hard disk device and various memory. The memory unit 104 stores the power control table 201 referenced by the judgement unit 103 and the control unit 102 for the judgement process and the battery control process, as well as the remaining power table 202 indicating the power in each power cell of the mega-battery 110. The power control table 201 and the remaining power table 202 are described in detail later.

The instruction unit 105 transmits a discharge instruction via the communication network 160 to the condominiums 120a, 120b, and 120c or to the mega-battery 110, in accordance with content of a notification from the control unit 102. The instruction unit 105 also transmits, in accordance with content of the notification from the control unit 102, a discharge instruction for the sub-battery 123 to discharge to the condominiums 120a, 120b, and 120c, and a request instruction via the communication network 160 for power constraint control by the HEMS 124. The instruction unit 105 transmits the payment request for money resulting from the incentive process to the bank 140, via the communication network 160.

The power acquisition unit 106 acquires a remaining power for each power cell in the mega-battery 110 and updates the remaining power table 202 in the memory unit 104 accordingly.

This concludes the description of the aggregator 100 configuration.

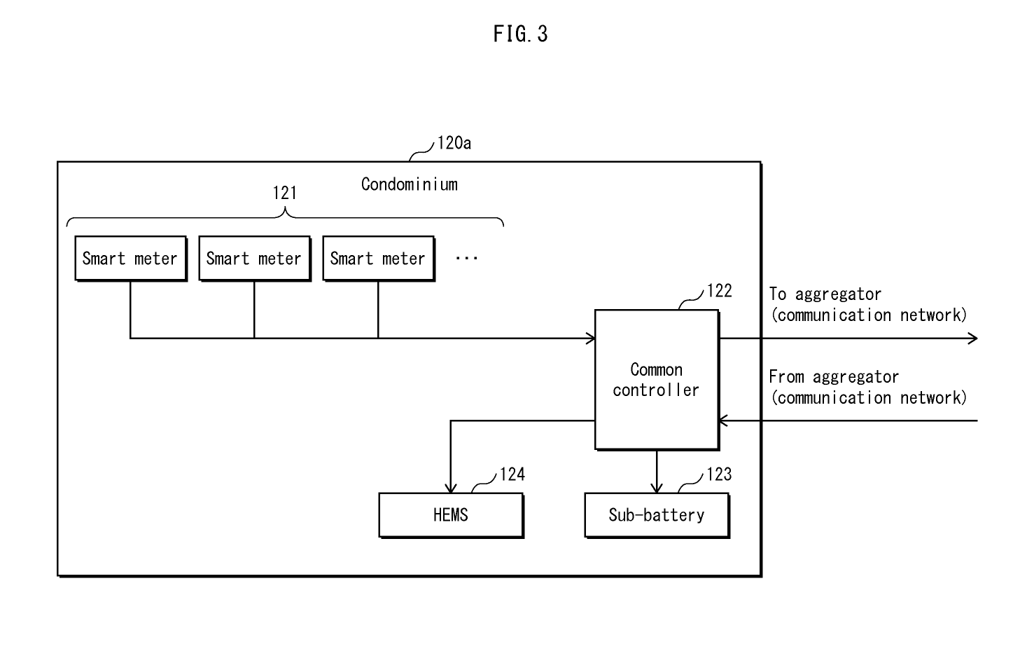

FIG. 3 is a block diagram illustrating the configuration of each condominium. The condominiums have identical configurations. The following describes condominium 120a.

The condominium 120a includes a smart meter group 121 corresponding to the units in the building, a common controller 122, a sub-battery 123, and an HEMS 124. The sub-battery 123 and the HEMS 124 may not be provided to certain condominium.

The smart meters in the smart meter group 121 are provided in correspondence with units (i.e., households) within the condominium and sequentially notify the common controller 122 of the consumed amount.

The common controller 122 controls the power supply system within the condominium 120a. The common controller 122 receives the consumed amount as notified by the smart meter group 121, calculates the total, and notifies the aggregator 100 of the total consumed amount calculated for each condominium, via the communication network 160. The common controller 122 also executes discharge of the sub-battery 123 and causes the HEMS 124 to perform the power constraint control, in accordance with an instruction from the aggregator 100 received via the communication network 160.

The sub-battery 123 is a battery provided to the condominium 120a that supplies power to each unit of the condominium 120a in accordance with an instruction from the common controller 122. Also, when not being discharged, the sub-battery 123 also charges from power supplied by the power distribution system 150.

The HEMS 124 executes control of electric appliances in each unit of the condominium 120a in accordance with an instruction from the common controller 122, and performs control so as to constrain the consumed amount. In recent years, various technologies have been disclosed as control methods for electric appliances via HEMS. The details of the HEMS are therefore omitted. For instance, Patent Literature 2 discloses an example of an HEMS.

For ease of explanation, the common controllers in each condominium 120a, 120b, and 120c are hereinafter indicated as common controller 122a, 122b, and 122c.

This concludes the description of the condominium configuration.

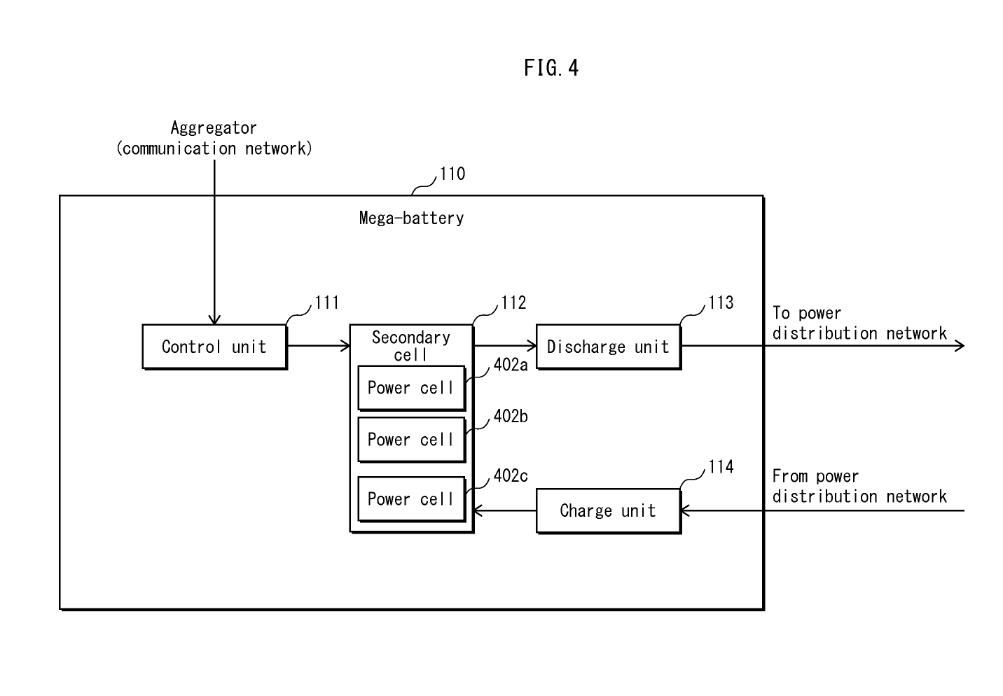

FIG. 4 is a block diagram illustrating the functional configuration of the mega-battery 110.

The mega-battery 110 includes a control unit 111, a secondary cell 112, a discharge unit 113, and a charge unit 114.

The control unit 111 controls charge and discharge of power cells in accordance with an instruction from the aggregator 100 received via the communication network 160.

The control unit 111 also sequentially (e.g., once per minute) detects the remaining power in each power cell 402a, 402b, and 402c and makes a notification to the aggregator 100 via the communication network 160. The control unit 111 associates the remaining power with an identifier identifying the power cell and makes the notification such that the aggregator 100 can identify which power cell has what remaining power.

The secondary cell 112 includes the power cells 402a, 402b, and 402c. Here, power cell 402a is for condominium 120a, power cell 402b is for condominium 120b, and power cell 402c is for condominium 120c. To be precise, the power cells are owned by the owner or residents of each condominium.

The discharge unit 113 performs discharge of power supplied by the secondary cell 112 to the power distribution system 150.

The charge unit 114 charges the power cells in the secondary cell 112 using commercial power supplied through the power distribution system 150. When the discharge unit 113 is not performing discharge and the remaining power in a given power cell is below a predetermined threshold, the charge unit 114 charges the given power cell.

This concludes the description of the mega-battery 110.

### (Data)

The data used by the aggregator 100 are described in detail below.

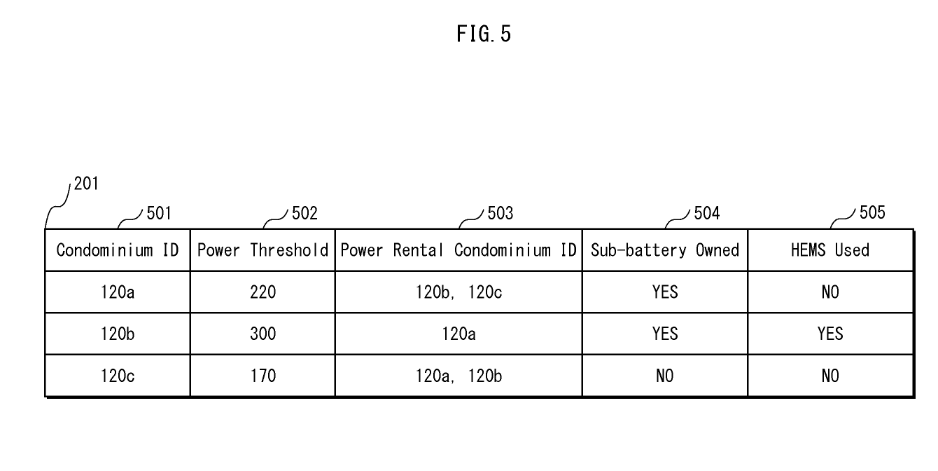

FIG. 5 is a schematic diagram of a data configuration for the power control table 201.

As shown, the power control table 201 includes a condominium ID column 501, a power threshold column 502, a power rental condominium ID column 503, a sub-battery owned column 504, and an HEMS used column 505.

The condominium ID column 501 lists an identifier used by the aggregator 100 for identifying each condominium. For ease of understanding, the reference signs assigned to each condominium in FIG. 1 are used. In actuality, the condominiums each use a device number of the common controller, a MAC address, or similar.

The power threshold column 502 indicates a threshold set for each condominium, corresponding to the condominium ID column 501, in order to realise the consumed amount peak cut, and indicates a consumed amount per minute (in kW). When the condominiums receive power through the high-voltage collective reception scheme, the power threshold column 502 is set below a value a reference point at which an increase in power fees occurs.

The power rental condominium ID column 503 lists an identifier of a condominium having a power cell from which the condominium listed in the corresponding condominium ID entry is able to rent power. Here, the power rental condominium ID column 503 lists the reference sign of a condominium as used in FIG. 1, much like the condominium ID column 501. However, in actually, the MAC address or the device number of the common controller of each condominium is used.

The sub-battery owned column 504 indicates whether or not the condominium listed in the corresponding condominium ID column 501 has a sub-battery. In FIG. 5, this column reads YES to indicate that a sub-battery is owned and NO to indicate that no sub-battery is owned. However, in actuality, two values are stored, namely one (to indicate that a sub-battery is owned) and zero (to indicate that no sub-battery is owned).

The HEMS used column 505 indicates whether or not the condominium listed in the corresponding condominium ID column 501 uses an HEMS. In FIG. 5, this column reads YES to indicate that HEMS is used and NO to indicate that no HEMS is used. However, in actuality, two values are stored, namely one (to indicate that HEMS is used) and zero (to indicate that no HEMS is used).

According to FIG. 5, condominium 120a has a power threshold of 220 kW for the peak consumed amount, and has condominiums 120b and 120c listed as power rental condominium from which to rent power when discharge from power cell 402a, owned by condominium 120a, is not sufficient to cause the consumed amount to stay equal to or below the power threshold. The condominium 120a has the sub-battery equipped and does not use the HEMS.

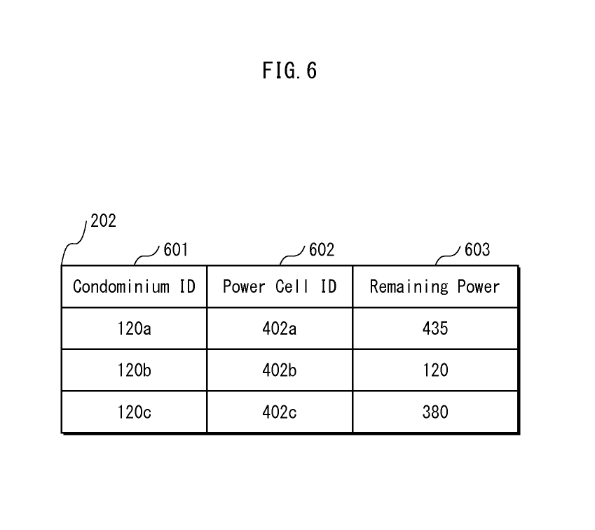

FIG. 6 is a schematic diagram of a data configuration for the remaining power table 202.

The remaining power table 202 has a condominium ID column 601, a power cell ID column 602, and a remaining power column 603.

The condominium ID column 601 lists an identifier used by the aggregator 100 for identifying each condominium, identical to the content of the condominium ID column 601. For ease of understanding, he reference signs assigned to each condominium in FIG. 1 are used. In actuality, the condominiums each use a device number of the common controller, a MAC address, or similar.

The power cell ID column 602 lists an identifier identifying each power cell in the mega-battery 110 as owned by a condominium listed in the corresponding entry of the condominium ID column 601. For ease of understanding, FIG. 4 describes each power cell with a reference sign assigned thereto. In actuality, the power cells each have a cell number allocated thereto, or some other identifier.

The remaining power column 603 lists the remaining power (in kW) of the power cell owned by the condominium listed in a corresponding entry of the condominium ID column 601. The remaining power is also termed remaining battery power.

According to FIG. 6, the power cell owned by condominium 120a is power cell 402a, which has 435 kW of remaining power.

### (Operations)

The operations of the battery control system pertaining to present Embodiment are described with reference to the flowcharts of FIGS. 7-9.

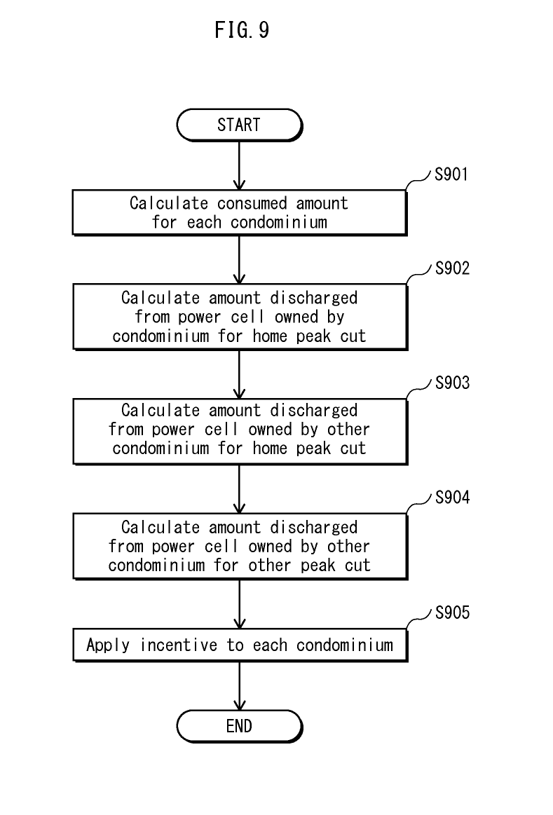

FIGS. 7 and 8 are flowcharts of the operations involved in the judgement process and the battery control process by the battery control system. FIG. 9 is a flowchart of detailed operations involved in the incentive process by the battery control process.

First, the power acquisition unit 106 of the aggregator 100 acquires the remaining power from each power cell 402a, 402b, and 402c in the mega-battery 110 (step S701). Upon obtaining the remaining power from the power cells 402a, 402b, and 402c, the power acquisition unit 106 updates the remaining power column 603 of the remaining power table 202 for the corresponding entries in the condominium ID column 601.

Next, the consumed amount acquisition unit 101 of the aggregator 100 acquires the amount consumed by each of the condominiums from the respective common controllers 122a, 122b, and 122c of the condominiums 120a, 120b, and 120c, and transfers the results to the control unit 102 (step S702)

Once the consumed amount for each condominium 120a, 120b, and 120c has been transferred, the judgement unit 103 of the control unit 102 calculates a sum of consumed amount (i.e., the total consumed amount). The judgement unit 103 also calculates the sum of the entries in the power threshold column 502 of the power control table 201 (i.e., the total power threshold). The judgement unit 103 then judges whether or not the total consumed amount exceeds the total power threshold (step S703).

When the consumed amount does not exceed the total power threshold (NO in step S703), the process ends.

When the consumed amount exceeds the total power threshold (YES in step S703), the judgement unit 103 compares the consumed amount for each condominium to the respective power threshold set therefor, judges whether the consumed amount by each condominium exceeds the power threshold set therefor, and specifies a condominium with a high consumed amount (step S704). That is, the judgement unit 103 references the power control table 201 for each condominium, obtains the power threshold for the corresponding condominium ID, and compares the respective consumed amounts. Accordingly, the judgement unit 103 specifies the condominium using power in excess of the power threshold. The judgement unit 103 then transfers the condominium ID of the specified condominium to the control unit 102, along with a notification indicating that the total consumed amount exceeds the total power threshold.

The control unit 102 then references the remaining power table 202 and specifies the entry in the power cell ID column 602 corresponding to an entry in the condominium ID column 601 for which the notification was made. Next, the control unit 102 makes a request to the instruction unit 105 to instruct the specified power cell to discharge. The instruction unit 105 thus makes a discharge instruction to the mega-battery 110 such that the power cell indicated by the control unit 102 is discharged (step S705). Upon receiving this instruction, the control unit 111 of the mega-battery 110 executes the discharge instruction with the indicated power cell. The discharge unit 113 discharges power from that power cell to the power distribution system 150.

The control unit 102 references and acquires the remaining power of the power cell from the remaining power column 603 of the remaining power table 202 when instructing the power cell to discharge. The control unit 102 then calculates a predicted total consumed amount by subtracting the total power discharged from the total consumed amount. Then, the judgement unit 103 of the control unit 102 makes a judgement regarding whether or not the predicted total consumed amount is less than the total power threshold (step S706).

In the affirmative case (YES in step S706), the control unit 102 performs the incentive process (step S707). The details of the incentive process are described later.

In the negative case (NO in step S706), the control unit 102 references the power rental condominium ID column 503 of the power control table 201 to determine whether or not the condominium specified in step S704 is able to rent power from another condominium (step S708).

When a condominium is available for power rental (YES in step S708), the control unit 102 subsequently makes a judgement regarding whether or not the condominium specified in step S704 has rented power from all condominiums from which power is rentable (step S709).

When power has not yet been rented from all available condominiums (NO in step S709), the control unit 102 executes the discharge instruction for the power cell of a condominium from which power has not yet been rented (step S710) and then returns to step S706. Such an iteration of step S706 will involve calculating the predicted total consumed amount by subtracting the power discharged in steps S705 and S710 from the total consumed amount.

When no condominium is available for power rental (NO in step S708), or when the condominium specified in step S704 has already rented power from all available condominiums (YES in step 709), the process advances to step S711 of FIG. 8.

The control unit 102 references the sub-battery owned column 504 of the power control table 201 to judge whether or not the condominium specified in step S704 has a sub-battery (step S711).

In the affirmative case (YES in step S711), the control unit 102 uses a log to make a judgement regarding whether or not a discharge instruction has already been executed for that sub-battery (step S712).

When no discharge instruction has been executed for the sub-battery (NO in step S712), the control unit 102 makes a request to the instruction unit 105 for transmission of a discharge instruction to the sub-battery. The instruction unit 105 then makes an instruction via the communication network 160 to the common controller 122 of the condominium specified in step S704 such that the sub-battery is discharged (step S713). Upon receiving the instruction, the common controller 122 executes discharge of the sub-battery 123.

After executing the discharge of the sub-battery 123, the common controller 122 recalculates the consumed amount and transfers the result to the aggregator 100 via the communication network 160. The consumed amount acquisition unit 101 of the aggregator 100 transfers the received consumed amount to the control unit 102. The control unit 102 recalculates the total consumed amount (step S714) and the process returns to step S706 of FIG. 7.

When the condominium has no sub-battery 123 (NO in step S711), or when the sub-battery 123 has already executed a discharge instruction (YES in step S712), the control unit makes a judgement regarding whether or not the condominium specified in step S704 uses an HEMS, by referencing the HEMS used column 505 of the power control table 201 (step S715).

In the affirmative case (YES in step S715), the control unit 102 uses the log to determine whether or not a control instruction has already been made to constrain power using the HEMS (step S716).

Also, when no instruction has been made to constrain power using the HEMS (NO in step S716), the control unit 102 makes a request to the instruction unit 105 to output a power constraint instruction to the HEMS of the condominium specified in step S704. The instruction unit transfers the power constraint instruction to the common controller 122 of the specified condominium through the communication network 160 (step S717). Upon receiving the instruction, the common controller 122 of the condominium instructs the HEMS 124 to execute control for constraining power.

After the power constraint control by the HEMS 124, the common controller 122 recalculates the consumed amount and transmits the result to the aggregator 100 via the communication network 160. The consumed amount acquisition unit 101 of the aggregator 100 transfers the received consumed amount to the control unit 102. The control unit 102 recalculates the total consumed amount (step S718) and the process returns to step S706 of FIG. 7.

When the condominium does not use an HEMS (NO in step S715) or when the HEMS has already been instructed to constrain the power (step S716), the process returns to step S717 of FIG. 7.

The details of the incentive process from step S707 of FIG. 7 are described with reference to the flowchart of FIG. 9.

First, the control unit 102 calculates the consumed amount of each condominium (step S901).

Upon calculating the consumed amount for each condominium, the control unit 102 then calculates the amount of power discharged from the power cell of the mega-battery 110 owned by each condominium (i.e., the amount discharged in step S705 of FIG. 7) in order to perform the consumed amount peak cut therefor (step S902).

Next, the control unit 102 calculates the amount discharged from the power cells belonging to other condominiums (i.e., the amount discharged in step S710 of FIG. 7) in order to perform the peak cut of the consumed amount for that condominium (step S903).

Next, the control unit 102 calculates the amount discharged from the power cell of the mega-battery 110 belonging to each condominium (i.e., the amount discharged in step S710 of FIG. 7) in order to perform the peak cut for other condominiums (step S904).

The control unit 102 then performs arithmetic based on the amount discharged calculated in steps S901-S904 and a fee determined in advance for each step, thereby calculating the incentive for each condominium. Subsequently, the control unit 102 makes an instruction for the calculated incentive to be applied for each condominium. The instruction unit 105 makes a request, via the communication network 160, for the bank 140 to execute the application of the appropriate incentive to accounts corresponding each condominium. Essentially, the fee applied for the amount discharged in steps S901 and S902 is determined according to a contract with the power company 130, while the fee applied for the amount discharged in steps S903 and S904 is determined according to a contract between condominiums.

The operations indicated in FIGS. 7-9 are executed repeatedly.

Now, a specific example of the incentive process performed in accordance with the amount discharged in FIGS. 7-9 is described in correspondence with the above-described steps.

First, let the remaining power in the power cells 402a, 402b, and 402c belonging to the condominiums 120a, 120b, and 120c be as indicated in FIG. 6. Also, let the power threshold for the respective condominiums 120a, 120b, and 120c be set as indicated in FIG. 5. For FIG. 5, the total power threshold is 590 (i.e., 220+300+170).

Further, let the consumed amounts for the condominiums 120a, 120b, and 120c, obtained by the control unit 102 in step S702 of FIG. 7, be 210 kW, 480 kW, and 130 kW, respectively. Thus, the total consumed amount is 820 kW (i.e., 210 kW+480 kW+130 kW). As such, the total consumed amount of 820 kW exceeds the total power threshold of 590 kW (YES in step S703). In this case, the power thresholds for each condominium are compared to find that the consumed amount for condominium 120b is 480 kW, which exceeds the power threshold of 300 kW set for condominium 120b. Therefore, condominium 120b is specified in step S704.

The control unit 102 then performs a discharge instruction for the power cell 402b of condominium 120b, and the mega-battery 110 performs discharge accordingly (step S705).

At this point, the remaining power in the power cell 402 is 120 kW, as indicated in FIG. 6. Thus, the predicted total consumed amount is 700 kW (i.e., 820 kW-120 kW). This value is not lower than the total power threshold of 590 kW (NO in step S706). The control unit 102 references the power control table 201 and detects condominium 120a as a condominium from which condominium 120b is able to rent power (YES in step S708).

The control unit 102 then makes a discharge instruction to power cell 402a, which is owned by condominium 120a. Here, making a discharge instruction for 110 kW (i.e., 700 kW-590 kW) enables realisation of the peak cut. With 435 kW remaining, power cell 402a is able to execute the discharge and achieve the goal (YES in step S706).

At this point, condominium 120b receives an incentive for the discharge in step S705 of 120 kW from power cell 402b from the power company 130 (i.e., the amount discharged in step S902), and condominium 120a pays an incentive to condominium 120a for the 110 kW of rented power (i.e., the amount discharged in step S903) rented from power cell 402a in step S710. Also, having performed power discharge of 110 kW for condominium 120b (i.e., the amount discharged in step S904), condominium 120a receives a corresponding incentive from condominium 120b.

### (Summary)

The above-described battery control system of Embodiment 1 provides the following benefits to residents of the condominium.

First, several condominiums receiving power supplied through a high-voltage collective reception scheme are able to estimate an increase in a target peak value and thus expect that the peak itself will be smaller. For instance, given a target value and supposing that condominium 120a has two peaks, in the morning and at night, while condominium 120b has only one peak at noon, then the target value for the two condominiums can be predicted to increase in the high-voltage collective reception scheme such that the actual peak may be reduced.

Conversely, the power cell in the mega-battery 110 owned by a condominium discharges to the power distribution system despite having produced a peak, which produces the appearance of the consumed power not having exceeded the target value. Thus, the determination is made that the peak has not been reached, and an increase in fees is accordingly constrained.

Also, when discharge from the power cell owned by a condominium is insufficient, discharge may be requested from a power cell of another condominium so as to similarly constrain any increase in fees.

### Embodiment 2

In Embodiment 1, a judgement is made regarding whether or not the sum of the consumed amounts for each condominium owning a cell in the mega-battery exceeds the total power threshold. This supposes that a plurality of condominiums use the high-voltage collective reception scheme to receive a supply of electric power. However, a peak cut similar to that described in Embodiment 1 is also realisable when the high-voltage collective reception scheme is used to supply power to individual condominiums.

Embodiment 2 discusses only the points of difference from Embodiment 1. Points of commonality with Embodiment 1 are omitted from the description.

### (Configuration)

In Embodiment 1, the judgement unit 103 of the aggregator 100 makes a judgement regarding whether the total consumed amount exceeds the total power threshold. However, Embodiment 2 does not perform this judgement.

Instead, the control unit 102 executes the battery control process when the consumed amount of any one of the condominiums 120a, 120b, and 120c exceeds the respective power threshold 502 set therefor.

That is, the storage battery control system pertaining to Embodiment 2 differs from Embodiment 1 in the trigger for the battery control process.

### (Operations)

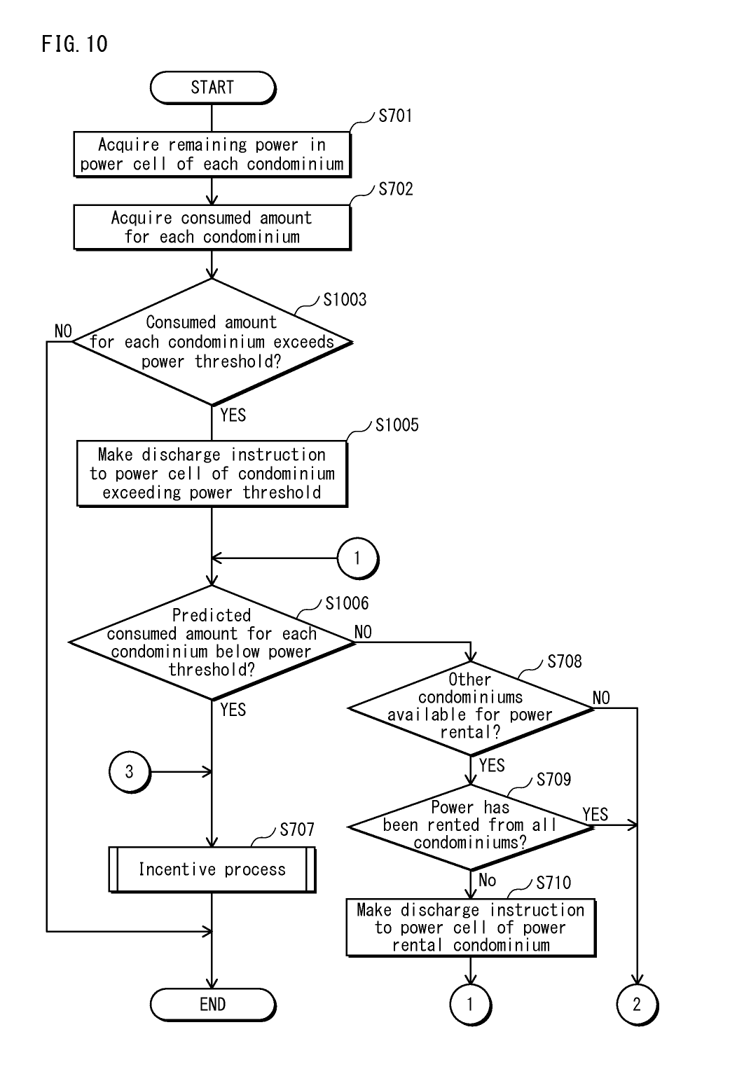

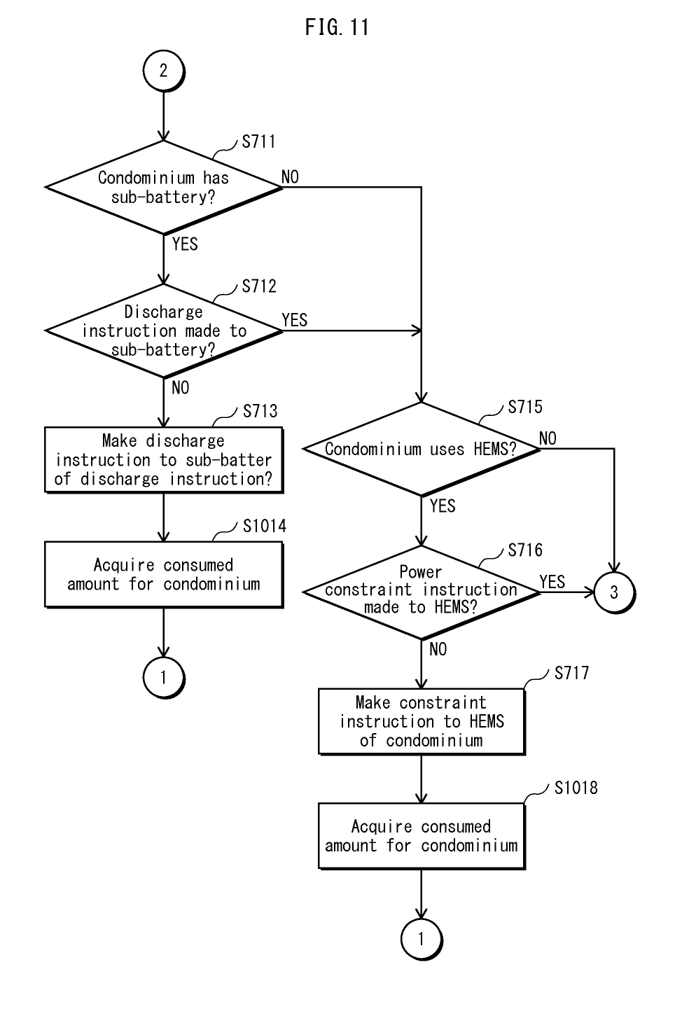

The operations of the storage battery control system pertaining to Embodiment 2 are described with reference to the flowcharts of FIGS. 10 and 11. Portions of FIGS. 10 and 11 having the same content as FIGS. 7 and 8 use the same reference signs thereas.

The storage battery control system pertaining to Embodiment 2 executes steps S1003-S1006 rather than steps S703-S706 of FIG. 7, and executes steps S1014 and S1018 rather than steps S714 and S718 of FIG. 8.

Upon receiving the consumed amount of each condominium 120a, 120b, and 120c from the consumed amount acquisition unit 101 of the aggregator 100, the judgement unit 103 makes a judgement regarding whether the respective consumed amount exceeds the corresponding power threshold 502 (step S1003).

When the consumed amount of each condominium does not exceed the corresponding power threshold 502 (NO in step S1003), the process ends.

However, when the consumed amount of any condominium exceeds the corresponding power threshold 502 (YES in step S1003), the control unit 102 transfers a discharge instruction to the instruction unit 105 for the power cell owned by the condominium having consumed power in excess of the power threshold 502. The instruction unit 105 then makes an instruction to the mega-battery 110 to discharge the appropriate power cell. The mega-battery 110 performs discharge of the corresponding power cell in accordance with the instruction and the discharge unit 113 discharges to the power distribution system 150 (step S1005).

A judgement is then made regarding the condominium having a consumed amount that exceeds the power threshold 502, by subtracting the amount discharged by the power cell from the consumed amount to obtain a predicted consumed amount and determining whether or not the predicted consumed amount is lower than the power threshold 502 (step S1006). The process then continues according to the results of this judgement.

Also, there is no need to obtain the total consumed amount in steps S1014 and S1018, which are performed instead of steps S714 and S718. Thus, in Embodiment 2, the consumed amount for the condominium found in step S1003 to be exceeding the power threshold 502 is used directly.

According to this configuration, the storage battery control system pertaining to Embodiment 2 allows a mega-battery to be shared among a plurality of condominiums while also providing a reduction in electric power fees for each condominium when the condominiums receive electric power supplied by distinct high-voltage collective reception schemes.

### Embodiment 3

Embodiments 1 and 2, described above, give examples of a method for a peak cut of electric power. In Embodiment 3, an example is given of a method for a further peak cut.

The storage battery control system pertaining to Embodiment 3 performs the power supply control described above in Embodiments 1 and 2 on the scale of the community rather the on the scale of a condominium. In Embodiment 3, the community includes is a unit owning a share of a mega-battery 110 as described in Embodiments 1 and 2, and includes one or more consumers (i.e., a household or condominium receiving electric power) and one or more mega-batteries corresponding to those consumers.

In Embodiments 1 and 2, the explanations pertain to performing a peak cut to power for a plurality of consumers (i.e., condominiums) belonging to a single community. However, Embodiment 3 discusses performing the peak cut at the community level, for a plurality of communities each made up of a plurality of consumers.

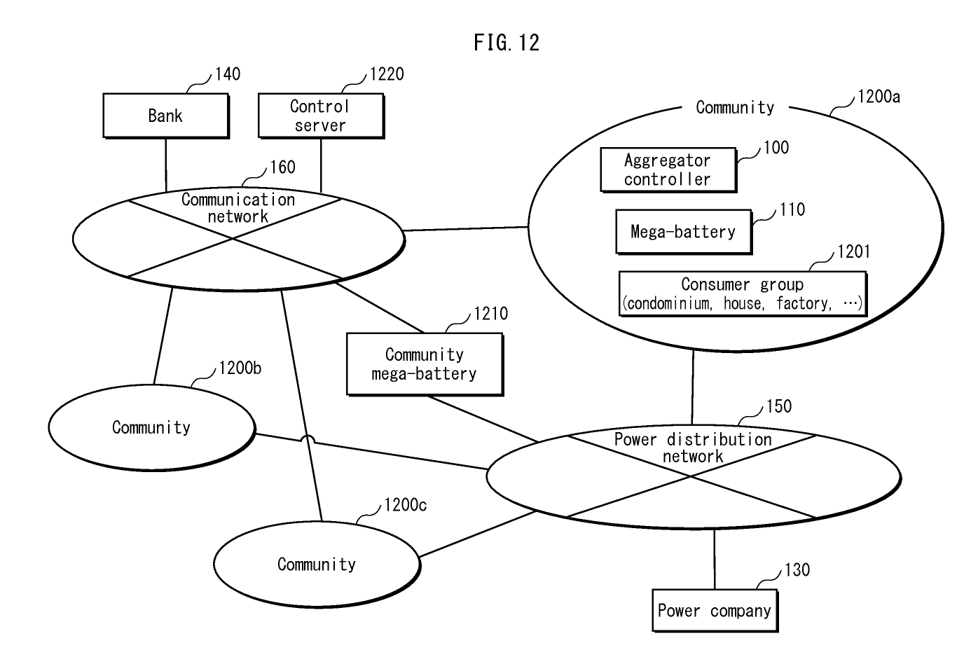

FIG. 12 is a system diagram indicating the configuration of the battery control system pertaining to Embodiment 3. FIG. 12 uses the same reference signs as FIG. 1 for points of commonality therewith, and explanations of such points are omitted.

As shown, the battery control system includes communities 1200a, 1200b, and 1200c, a community mega-battery 1210, and a control server 1220. The communities and the control server 1220 are connected via the communication network 160. Each community is also connected to the power distribution system 150. A consumer that is a member of one of the communities receives commercial power supplied from the power company 130 also connected to the power distribution system 150. The community mega-battery 1210 is also connected to the power distribution system 150.

As described in Embodiments 1 and 2, each community includes an aggregator 100 connected to the communication network 160, a mega-battery 110 connected to the power distribution system 150, and a consumer group 1201 (i.e., a condominium, a house, a factory, or the like) connected to the power distribution system 150. In FIG. 12, the internal structure of the community and the precise connection thereof to the power distribution system 150 and the communication network 160 are not indicated for the sake of clarity. The internal structure of the community is as indicated by the connections illustrated in FIG. 1. Although not shown in FIG. 12, communities 1200b and 1200c are configured identically to community 1200a. The term community is used here for convenience, though the system may also be managed on the scale of an area (i.e., a service area where buildings requiring power are located). Each community includes one or more consumer requiring power, a mega-battery, and an aggregator.

The community mega-battery 1210 is a large-capacity storage battery that is connected to the control server 1220 via the communication network 160. The community mega-battery 1210 is also connected to the power distribution system 150, discharges to the power distribution system 150, and charges from the power distribution system 150. The community mega-battery 1210 is configured similarly to the mega-battery 110 described above in Embodiments 1 and 2 (see FIG. 4). However, unlike the example illustrated in FIG. 4, the control unit of the community mega-battery 1210 (corresponding to the control unit 111 of the mega-battery 110) performs charge and discharge to and from the power distribution system 150 in accordance with an instruction from the control server 1220. Also, in Embodiments 1 and 2, each power cell of the mega-battery 110 is owned by one of the condominiums. In contrast, in Embodiment 3, a power cell of the community mega-battery 1210 performs discharge according to an upper limit amount of usable power set for each community at each time slot, having at least one power cell. The power cells of the community mega-battery 1210 also charge by receiving power from the power distribution system 150.

The control server 1220 is connected to each member of the community and to the community mega-battery 1210, via the communication network 160. The control server 1220 corresponds to the aggregator 100 controlling the mega-battery 110 and connected to the condominiums, as described in Embodiments 1 and 2. That is, the control server 1220 controls the community mega-battery 1210. Unlike the aggregator 100, which executes discharge of the mega-battery 110 in accordance with power usage conditions of the condominiums, the control server 1220 causes the community mega-battery 1210 to discharge in accordance with power usage conditions of the communities.

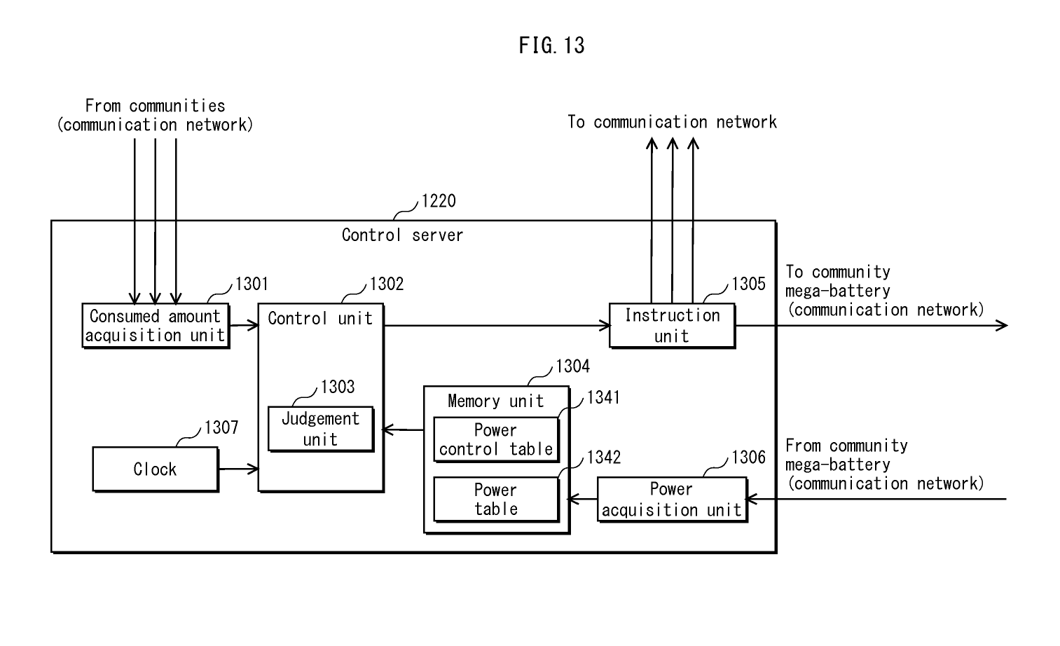

FIG. 13 is a block diagram illustrating the functional configuration of the control server 1220. As shown, the control server 1220 includes a consumed amount acquisition unit 1301, a control unit 1302, a memory unit 1304, an instruction unit 1305, a power acquisition unit 1306, and a clock 1307.

The consumed amount acquisition unit 1301 acquires a total amount of power used by each community and transfers the result to the control unit 1302. The aggregator 100 is provided for each community, and the aggregator 100 thus acquires the total consumed amount used by the corresponding community. As such, the consumed amount acquisition unit 1301 acquires the total consumed amount used by all the communities from the aggregator 100.

The control unit 1302 of the control server 1220 has the same functions as the aggregator 100 described in Embodiments 1 and 2, with the addition of control based on the amount of usable power, which changes over time. That is, in Embodiments 1 and 2, an example is described where the power cells were owned by the condominiums. However, in Embodiment 3, the power cells are divided in time units. In other words, the following explanation is given for a situation where the amount of power used by each community at a given time (and the amount of power discharged by the community mega-battery 1210 when the power threshold is exceeded) has been defined.

When the judgement unit 1303 of the control server 1220 finds that the consumed amount of a community has exceeded a threshold set for that community, the control unit 1302 specifies an amount of usable power in the community mega-battery 1210 in accordance with a current time transmitted from the clock 1307 and a later-described power table 1342, and notifies the instruction unit 1305 so as to make an instruction for the community mega-battery 1210 to discharge with the specified amount as an upper limit.

The memory unit 1304 stores programs and data required for operating the control server 1220, and is realised as a recording medium such as a hard disk device and various memory. The memory unit 104 stores a power control table 1341 referenced by the judgement unit 1303 and the control unit 1302 for the judgement process and the battery control process, as well as the power table 1342 indicating the power usable by the communities for each time slot. The power control table 1341 and the power table 1342 are described in detail later.

The instruction unit 1305 transmits a discharge instruction via the communication network 160 to the community mega-battery 1310, in accordance with content of a notification from the control unit 1302. The instruction unit 1305 also transmits the payment request for money resulting from the incentive process to the bank 140, via the communication network 160, in accordance with the notification from the control unit 1302.

The power acquisition unit 1306 acquires a remaining battery power from the community mega-battery 1310.

The clock 1307 sequentially transmits a current time to the control unit 1302.

Accordingly, the control server 1220 is able to perform a peak cut of power, similar to Embodiments 1 and 2, at the community scale.

### (Data)

The power control table 1341 and the power table 1342 stored in the memory unit 1304 of Embodiment 3 are described below.

Although not illustrated, the power control table 1341 is configured nearly identically to the power control table 201 shown in FIG. 5 and pertaining to Embodiment 1. However, the condominium ID column 501 is replaced with a community ID column and the power rental condominium ID column 503 is replaced with a power rental community ID column. Also, the power control table 1341 does not include the sub-battery owned column 504 and the HEMS used column 505. Accordingly, the power control table 1341 includes information such as a community ID, the power threshold set for the community, and a power rental community ID specifying another community from which power can be rented, stored in association.

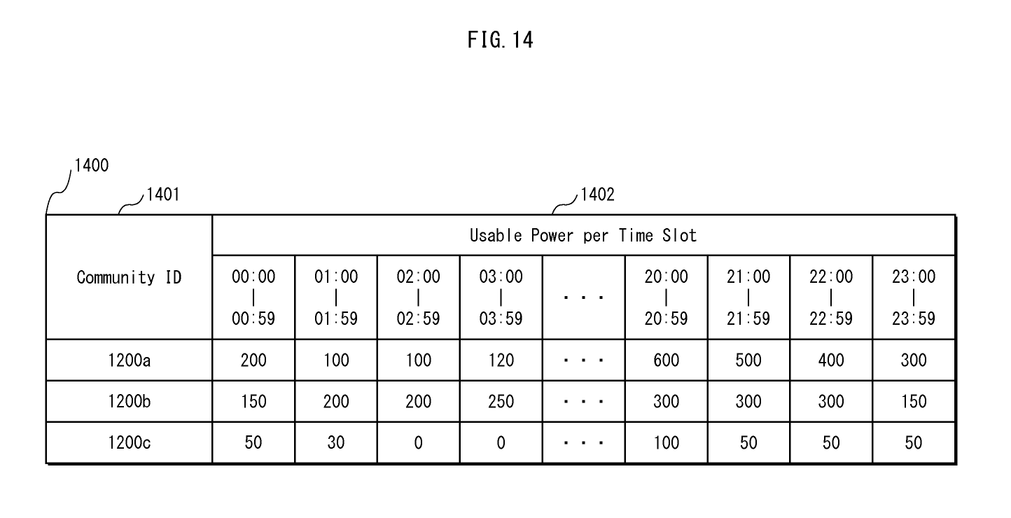

The memory unit 1304 of the control server 1220 stores the a control table indicating an amount of usable power per unit time for each community. FIG. 14 is a schematic diagram of a data configuration for the control table.

As shown, the control table includes a community ID column 1401, specifying each community, and a usable power column 1402 indicating an amount of usable power at each time slot during one day for the associated community.

The community ID column 1401 lists an identifier used by the control server 1220 to identify the communities. The community ID corresponds to the condominium ID given in FIG. 5.

As shown, the usable power column 1302 indicates an amount of power dischargeable from the community mega-battery 1210 at each time slot of the day when the community has exceeded the power threshold. In the example of FIG. 14, communities 1200a, 1200b, and 1200c have respective values of 100 MW, 200 MW, and 30 MW set in the usable power 1302 for the time slot of 1:00 to 1:59. That is, for instance, when the total power used by community 1200a in the time slot of 1:00 to 1:59 exceeds the power threshold set for community 1200a, the control server 1220 is able to cause the community mega-battery 1210 to discharge up to 100 MW. These values are given only as examples, and are set according to the scale of the respective communities.

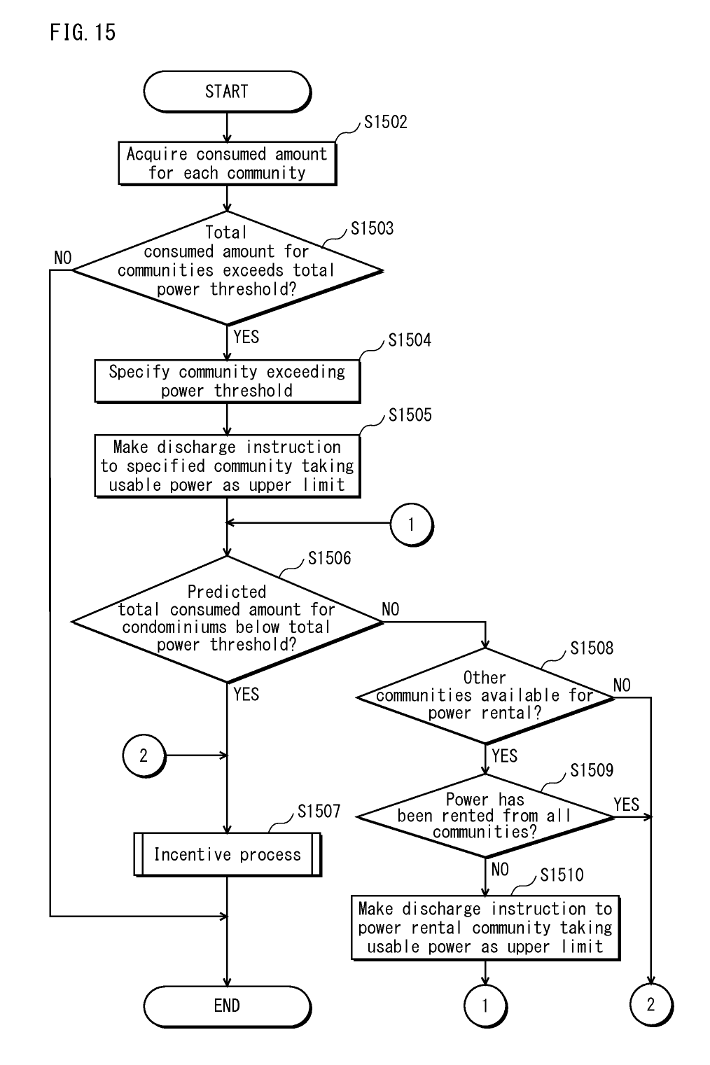

The control server 1220 uses the power table 1342 of FIG. 14 to execute the control indicated in FIG. 15 in accordance with fluctuations in power usage over time.

### (Operations)

FIG. 15 is a flowchart illustrating the control process pertaining to Embodiment 3, performed by the control server 1220 when controlling the community mega-battery 1210. The operations of control server 1220 include operations similar to those of the aggregator 100 described in Embodiment 1, the explanations of which are omitted. The control server 1220 may of course also be considered similar to the aggregator 100 of Embodiment 2 rather than the aggregator 100 of Embodiment 1.

As shown in FIG. 15, the consumed amount acquisition unit 1301 of the control server 1220 acquires the total consumed amount of power consumed by the communities, from the aggregator 100 of each community (step S1502).

Upon receiving the consumed amount for the communities, the judgement unit 1303 calculates the total consumed amount according to a time in a notification from the clock 1307. The judgement unit 1303 then compares the total consumed amount to the total power threshold and determines whether or not the total consumed amount exceeds the total power threshold (step S1503).

When the consumed amount does not exceed the total power threshold (NO in step S1503), the process ends.

When the consumed amount exceeds the total power threshold (YES in step S1503), the judgement unit 1303 compares the consumed amount of each community to the respective power threshold set for that community to determine which of the communities has a consumed amount exceeding the power threshold, and specifies the community having the greatest consumed amount (step S1504). That is, the judgement unit 1303 references the power control table 1341 for each community, obtains the power threshold for the corresponding community ID, and compares the respective consumed amounts. Accordingly, the judgement unit 1303 specifies the community using power in excess of the power threshold. The judgement unit 1303 then transfers the community ID of the specified community to the control unit 1302, along with a notification indicating that the total consumed amount exceeds the total power threshold.

The control unit 1302 then uses the time from the clock 1307 and the power table 1342 to identify the usable power corresponding to the community ID column 1401 entry matching the notification. Afterward, the control unit 1302 makes a request to the instruction unit 1305 for discharge, taking the specified usable power as an upper limit. The instruction unit 1305 then makes a discharge instruction to the community mega-battery 1210 (step S1505). Upon receiving the instruction, a control unit of the community mega-battery 1210 causes the power cell to discharge power to the power distribution system 150, taking the specified amount as an upper limit.

The control unit 1302 makes the discharge instruction and also computes the predicted total consumed amount by subtracting a total of power discharged from the community mega-battery 1210 (i.e., the difference in power before and after discharge) from the total consumed amount. Then, the judgement unit 1303 of the control unit 1302 makes a judgement regarding whether or not the predicted total consumed amount is less than the total power threshold (step S1506).

In the affirmative case (YES in step S1506), the control unit 1302 performs the incentive process (step S1507). The details of the incentive process are omitted from this explanation as the process resembles that described in Embodiment 1 with reference to the flowchart of FIG. 9. The difference is that where FIG. 9 refers to calculations for condominiums, the process performed in Embodiment 3 makes calculations for communities.

In the negative case (NO in step S1506), the control unit 1302 references the power rental community ID column of the power control table 1341 to determine whether or not the community specified in step S15047 is able to rent power from another community (step S1508).

When a community is available for power rental (YES in step S1508), the control unit 1302 proceeds to determine whether or not the community specified in step S1504 has already rented power from all communities available for power rental (step S1509).

In the negative case (NO in step S1509), the control unit 1302 executes a discharge instruction to discharge power from a community from which power has not yet been rented, taking the amount of usable power as an upper limit (step S1510), and then returns to step S1506. Such an iteration of step S1506 will involve calculating the predicted total consumed amount by subtracting the power discharged in steps S1505 and S1510 from the total consumed amount.

When no community is available for power rental (NO in step S1508) or when power has already been rented from all communities (YES in step S1509), the process advances to step S1507.

Accordingly, the control server 1220 is able to execute a peak cut on a large scale, greater than the scale controlled by the aggregator 100.

Also, determining the amount of usable power per unit time enables more dynamic control to be performed. As such, a user of the battery control system is provided with a more convenient battery control system with a smaller load.

Although not described in Embodiment 3, the aggregator 100 of each community also performs the control described in Embodiments 1 and 2 on the mega-battery 110 shared within each community, in accordance with power used by the consumer group belong to the respective communities.

### (Variations)

The battery control system of the disclosure has been described with reference to the above Embodiments. However, no particular limitation thereto is intended. The following variations are also included in the scope of the disclosure.

(1) In the above-described Embodiments, the mega-battery 110 supplies power to the power distribution system 150. However, no such limitation is intended. The mega-battery may be connected directly to the power company 130 acting as service provider for commercial power, or may supply power directly to each condominium 120a, 120b, and 120c. When passed directly to the power distribution system 150 or to the power company 130, the power cut appears to be realised and enables a reduction in electricity fees according to the contract with the power company 130. Also, when the condominiums 120a 120b 120c have power supplied thereto directly by the mega-battery 110, then prioritizing this power enables a reduction in the amount of commercial power that is used, which is realised in practice as a peak cut that reduces electricity fees.

Also, when the condominiums each receive power directly from the mega-battery 110, then the amount of power used thereby is detectable separately by distinguishing between the commercial power and the power from the mega-battery 110. Accordingly, assistance is provided in the calculation of electricity fees, for example.

(2) In the above-described Embodiments, the mega-battery 110 is divided according to ownership, and the condominiums 120a, 120b, and 120c each own a respective power cell 402a, 402b, and 402c within the mega-battery 110. However, the condominiums are not limited to owning only one power cell, and may each own a plurality of power cells. Also, the quantity of power cells owned by each condominium may differ.

Further, in the above-described Embodiments, the condominiums are described as owning the power cells. However, this may also be realised as rental rather than ownership, or any other right to use the power cells. For example, the condominiums may have a monetary contract with an operator operating a mega-battery 110 rental service, providing the right to use the power cells in the mega-battery 110.

(3) In the above-described Embodiments, the mega-battery 110 is divided according to ownership, and the condominiums 120a, 120b, and 120c each own a respective power cell within the mega-battery 110. However, this is not limited to actual ownership of the power cells. For example, a method may be used in which the power in the mega-battery is set to an amount of usable power for unit time for each of the condominiums. In such a situation, the amount of power supplies is set more dynamically than is possible when the power cells are owned.
(4) In the above-described Embodiments, the incentive involves the owner of a condominium paying a fee to the owner of another condominium upon renting power therefrom. However, there is no need to exchange cash. The incentive may also involve renting power back to the condominium from which power was rented (i.e., reciprocally supplying commercial power or power from a power cell of the mega-battery in correspondence with the rented amount), or may involve an exchange of points redeemable for some other product, an exchange of goods, a discount on electricity fees redeemable with the power company 130, or a similar scheme.
(5) In the above-described Embodiments, an example is described in which the condominiums own the mega-battery 110 and power is discharged from the mega-battery 110. However, the owners need not be condominiums. Any facility requiring electric power may use the scheme. For instance, rather than condominiums, a plurality of single-family homes may use the scheme, or a plurality of factories, or some combination thereof. No limitation is intended provided that a plurality of facilities requiring electric power own the mega-battery 110.
(6) In the above-described Embodiments, the aggregator 100 is described as being configured such that different settings are used for the mega-battery 110 and for each of the condominiums 120a, 120b, and 120c. However, no such limitation is intended. Provided that the results described in the Embodiments are produced, the aggregator 100 may be provided within the mega-battery 110, or may be provided within the common controller 122 of condominium 120a.
(7) In Embodiment 1, the judgement unit 103 makes a judgement regarding whether or not the sum of power used by the condominiums exceeds a threshold, and performs the above-described controls. The threshold is set by acquiring a value in advance to serve as the peak and setting the threshold lower than that value, in consideration of electricity fee payment for the high-voltage collective reception scheme. Accordingly, constraint on power used is (apparently) performed before the peak is reached in order to constrain electricity fees. However, realisation of the peak cut may also be enabled through an approach other than judgement based on a threshold.

For example, a log may be kept of the total consumed amount, and this log may be used to compute a quadratic function relating to transitions in the consumed amount. The mega-battery 110 may then be discharged when the value serving as the peak based on such a calculation is approached for at least a fixed duration, i.e., when the predicted calculation of the consumed amount is performed.

(8) In the above-described Embodiments, a power constraint control is executed by the HEMS when the power discharged by the mega-battery is insufficient despite discharge from power cells owned by other condominiums. However, the power constraint control by the HEMS need not necessarily be performed at this time, provided that the ultimate result is that the peak cut is realised. For example, the power constraint control by the HEMS may be performed first when the power consumed by the condominium exceeds the power threshold 502 set for that condominium, and the mega-battery 110 may discharge power when the power constraint control is nevertheless insufficient (i.e., when the peak cut is not achieved). Alternatively, the corresponding power cell may perform discharge, followed by the power constraint control by the HEMS when power is insufficient, and power may be rented from power cells of other condominiums if the power still remains insufficient.

The same applies to discharge from the sub-battery when provided in the condominium.

That is, with reference to the flowcharts of FIGS. 7 and 8, where steps S708-S710 constitute a first discharge process, steps S711-S714 constitute a second discharge process, and steps S715-S718 constitute a third discharge process, then the order of execution need not necessarily be first, second, third but may be second, third, first, or first, third, second.

(9) In the above-described Embodiments, an example is described in which the consumed amount for the condominiums exceeds the power threshold set for a corresponding condominium. However, in such a situation, a priority may also be set for each condominium and the process of FIGS. 7-9 may be performed in descending priority order. Alternatively, after discharging power from the power cell of a condominium having exceeded the power threshold, power rental may then be performed in accordance with the respective priority of the condominiums.
(10) In the above-described Embodiments, for ease of explanation, the smart meters are provided to detect an amount of power consumed in each of the condominiums, and the aggregator 100 obtains these amounts for comparison with the respective thresholds. However, the following alternate configuration is also possible.

That is, a typical smart meter may be provided in each unit of the condominium and the aggregator 100 may acquire the consumed amount from all of these smart meters. In such a situation, the aggregator 100 stores a table in which an ID or similar for each unit's smart meter is associated with the corresponding condominium, and acquires the consumed amount for each unit of the condominium so as to compute the total and acquire the amount of power used by the entire condominium.

According to this configuration, the amount of power consumed is acquired as described in the above Embodiments.

(11) In Embodiment 1, the total power threshold is sum of the power thresholds set for each of the condominiums. However, no such limitation is intended. The total power threshold may be set as a predetermined value that is not the sum of the power thresholds set for each of the condominiums.

In such a case, depending on the total power threshold, the total consumed amount may exceed the total power threshold despite no condominium exceeding the power threshold set therefor. When this occurs, step S704 does not specify the condominium exceeding the power threshold but rather specifies a condominium having the greatest consumed amount, and the process from step S705 onward is performed for the specified condominium.

(12) In the above-described Embodiments, the power control by the aggregator 100 is executed once per minute upon receiving the notification by the common controller of the condominium. However, this is simply intended as an example. Other intervals are also possible, and may be longer such as once every ten minutes or once per hour, or shorter such as once every 30 seconds. The time calculation may be made by actually running the battery control system and simulating an appropriate operation time.
(13) In the above-described Embodiments, the high-voltage collective reception scheme is presupposed in the explanations. However, the battery control system is not limited to the high-voltage collective reception scheme but may also use a low-voltage reception scheme. That is, although the above-described Embodiments indicate that the power threshold in the power control table 201 is set so as to be lower than a peak determined according to the high-voltage collective reception scheme, when a low-voltage reception scheme is used, the same results may be obtained by setting the power threshold according to a target fee budgeted by the user.
(14) The incentive process indicated in FIG. 9 of the above-described Embodiments includes amounts of power calculated in steps S901-S904 for use in the incentive calculation of step S905. The order of these calculations need not necessarily be as indicated in FIG. 9. Steps S901-S904 may be performed in any order, or even in parallel.
(15) In the above-described Embodiments, the incentive process is always performed. However, the incentive process may also be performed once a month, for instance, using a log recorded every time discharge is made from the mega-battery 110 to apply the incentive.

Also, in the above-described Embodiments, a request is made to the bank in order to pay the incentive. However, the aggregator 100 may also be provided with a monitor or other display device and display the calculated incentive thereon. In such a situation, the fees associated with the incentive are payable directly between residents of the condominiums, for example, by any selected payment method.

(16) In the above-described Embodiments, the charge unit 114 of the mega-battery 110 receives power supplied through the power distribution system 150 and performs power cell discharge. However, the charge unit 114 may not receive power supplied by the power distribution system 150 but rather from a generator device provided to the mega-battery 110 or connected to the mega-battery 110, and perform the power cell discharge accordingly. For example, the mega-battery 110 may be equipped with a solar panel, and perform power cell discharge using power generated by the solar panel.
(17) Although not described above, the incentive process of Embodiment 1 may also be performed as follows.

According to Embodiment 1, when the condominiums receive power through the high-voltage collective reception scheme, all of the condominiums may be considered to consume an average amount of power. That is, although an amount of consumed power may be considered to produce a power peak when the condominiums individually receive power supplied through the high-voltage collective reception scheme, the peak may not be considered reached when a plurality of condominiums receive power supplied through the high-voltage collective reception scheme.

For example, suppose that condominium 120a approaches the peak twice, in the morning and at night, while condominium 120b approaches the peak once, at noon. When the condominiums are considered individually, condominium 120a triggers an increase in electricity fees due to approaching the peak twice, and condominium 120b triggers an increase in electricity fees due to approaching the peak once. In contrast, when the condominiums jointly receive power supplied through the high-voltage collective reception scheme, the threshold for detecting the peak is expected to be higher, such that neither of the condominiums 120a and 120b are considered to have triggered the peak. Using this alternative perspective, the power not consumed by condominium 120b in the morning and at night is rented from condominium 120b to condominium 120a to cover the excess. The opposite occurs at noon.

Then, as per the flowcharts of FIGS. 7 and 8, when the control unit 102 of the aggregator 100 finds that the total consumed amount has not exceeded the total power threshold (NO instep S703), a further detection is made regarding whether or not any of the condominiums has exceeded the power threshold 502 set therefor. When one of the condominiums has exceeded the power threshold 502, the control unit 102 then calculates the amount of power consumed in excess and considers that amount to be rented from another condominium, and executes the incentive process using that amount such that the condominium having exceeded the power threshold 502 pays the other condominium. Specifically, for instance, the consumed amount in excess of the power threshold 502 is divided by the number condominiums not exceeding their respective power threshold, and the quotient so obtained corresponds to a fee (i.e., the incentive) paid by the condominium exceeding the power threshold 502 to the condominium not exceeding the threshold. In such a situation, the quotient may be added to an amount of power consumed by the condominium, and when this sum exceeds the power threshold 502 set for that condominium, the condominium may be considered to have received the difference found by subtracting the consumed amount from the power threshold 502.

Also, the incentive process described in Variation 17 may be applied to the incentive payment occurring when the total consumed amount exceeds the total power threshold (YES in step S703).

(18) In the above-described Embodiments, the power control table 201 is stored in the memory unit 104 in advance. The data thereof may also be input to the aggregator 100 by an operator. Further, information pertaining to the power threshold for the common controller of each condominium, the presence of the sub-battery, the use of the HEMS, and so on may be obtained automatically by the aggregator 100 to create the power control table 201.
(19) In Embodiments 1-3, the respective capacities of the mega-battery 110, the sub-battery 303, and the community mega-battery 1210 are not described in detail. Each of these components need only have a minimum capacity required for operation. That is, when the mega-battery 110 is used in Embodiment 1, for example, only the capacity contractually needed for each condominium 120a, 120b, and 120c is required. For instance, when the usable capacity per unit time is 120 kW for condominium 120a, 80 kW for condominium 120b, and 200 kW for condominium 120c, the battery need only have a discharge capacity of 400 kW for the corresponding unit of time. That is, although the term mega-battery is used in the above-described Embodiments, this is merely a name and is not intended as a limitation concerning the use of mega-units.

This also applies to the community mega-battery 1210 of Embodiment 3, which need only have sufficient capacity for a total number of watts contractually usable by the communities.

(20) In Embodiment 3, an example is described where an amount of power from the community mega-battery 1210 is set for each community to use per unit time, and the control server 1220 performs time-dependent control.

However, no limitation is intended to using time slots for control of the power in the community mega-battery 1210. The usable power may also be determined using a threshold for each community that varies over time.

(21) In Embodiment 3, the sub-battery and the HEMS are not considered. However, when consumers belong to the community and requiring power are provided with the sub-battery or the HEMS, then these may be used as described in Embodiments 1 and 2 to perform the power peak cut.
(22) In Embodiment 3, an example is described in which the communities use a community mega-battery 1210 in an amount that is controlled in hourly units. This unit of time is merely intended to represent that the amount of power may fluctuate over time, and no limitation to hourly units is intended. For example, units of 30 minutes or of two hours may also be used.
(23) The above-described Embodiments and Variations may be freely combined as appropriate.
(24) The operations pertaining to control of the mega-battery by the aggregator of the above-described Embodiments, the control process (FIGS. 7, 8, 10, 11, and 15), and the incentive process (FIG. 9) may be realised as a control program made up of program codes for execution by a processor in the aggregator or by circuits connected thereto, and the control program may be recorded on a recording medium or distributed through various communication lines. The recording medium may be an IC card, a hard disk, an optical disc, a floppy disc, ROM, or the like. The control program so distributed is then provided for use in a memory or the like readable by the processor, and the functions of the various Embodiments are realised by the processor executing the control program.
(25) The components of the above-described Embodiments may be realised as circuits each realising one of the corresponding functions, or as one or mire processors executing programs. Also, components of the storage battery control system of the above-described Embodiments may be realised as an integrated circuit (IC), a large scale integration (LSI), or some other integrated circuit package. The package may be incorporated in various devices which then realise the functions described in the Embodiments.

Each functional block is typically realised as an LSI. These may be realised individually on single chips, or one or all components may be included in a single chip. Although LSI is named above, any of IC, system LSI, super LSI, and ultra LSI may be used depending on the degree of integration. Also, no limitation is intended to LSI as the method of integration. A dedicated circuit or a general processor may also be used. After LSI manufacture, a FPGA (Field Programmable Gate Array) or a reconfigurable processor may also be used.

### (Supplement)

Aspects of the storage battery control system and storage battery control method are described below, along with their effects.

(a) In one aspect, a storage battery control method used by a control device controlling a storage battery (i.e., the mega-battery 110 or the community mega-battery 1210) prepared for a plurality of consumers (i.e., condominiums 120a, 120b, and 120c, and communities 1200a, 1200b, and 1200c), the storage battery control method including: detecting an amount of power used by each of the consumers per unit time (i.e., the consumed amount acquisition unit 101 in steps S702 and S1502); making a judgement regarding whether or not the amount of power used by one or more of the consumers exceeds a threshold determined in advance (i.e., the judgement unit 103 in steps S703 and S1003); and when the amount of power used by the consumers exceeds the threshold, supplying electric power from the storage battery to a power distribution system to which the one or more consumers belong (i.e., the control unit 102 and the discharge unit 113 in steps S705, S1005, and S1505).

Here, the consumer is any facility requiring electric power, such as a condominium, apartment building, factory, house, or community including multiple consumers requiring electric power.

Also, the power supplied through the power distribution system to the consumer is discharged to the power distribution system as described in the Embodiments and includes power directly supplied to the consumer.

According to this configuration, when the consumer has consumed an amount of power exceeding the threshold, power is discharged by a power cell to the power distribution system to which the consumer belongs. As such, the commercial power consumed and the power discharged from the power cell are used in a power trade that appears to lower electricity fees. Specifically, in a high-voltage collective reception scheme or the like where electricity fees increase in accordance with approaches to a peak power, this system results in reduction of large electricity fees.

(b) In another aspect, the threshold is a first threshold (i.e., the total power threshold of Embodiment 1 or the threshold of Variation 11) set with respect to a total amount of power used by the consumers, and the judgement is made regarding whether or not a total amount of power used by the consumers exceeds the first threshold.

According to this configuration, power is discharged from the power cell in accordance with a total consumed amount consumed by a plurality of consumers, and several collective housing units receiving electric power as a group through the high-voltage collective reception scheme effectively see a reduction in electricity fees.

(c) In a further aspect, a usable amount of power in the storage battery usable per unit time (i.e., the capacity of the power cell in the mega-battery 110 owned by the condominium in Embodiment 1, or see Variations 2 and 3) is defined for each of the consumers, when the judgement finds that the total amount exceeds the first threshold, a further judgement is made regarding whether or not the amount of power used by each of the consumers exceeds a second threshold corresponding to each of the consumers (i.e., the power threshold 502), and the electric power is supplied to the distribution system within a range indicated as the usable amount of power defined for a given consumer for which the further judgement finds that the amount of power used exceeds the second threshold corresponding thereto.

According to this configuration, a consumer in the consumer group who has consumed power in excess of an individual threshold, i.e., a consumer consuming more than an ordinary amount of power, is specified and the electricity fees are reduced by (apparently) reducing the power consumed by that consumer using an amount of usable power in a power cell set up for that consumer.

(d) In still another aspect, an additional judgement is made regarding whether or not a computed value also exceeds the first threshold, the computed value being a result of subtracting a supplied amount discharged from the storage battery from the amount of power supplied by the storage battery and consumed by the consumer, and the electric power is supplied to the power distribution system from the usable amount of power defined for another consumer, after the additional judgement finds that the computed value exceeds the second threshold set for that consumer.

According to this configuration, when discharge of the usable amount of power for usable by a consumer using a large amount of power does not result in staying below a target value (i.e., an individual threshold), power is rented from another consumer so as to effectively reduce electricity fees by (apparently) reducing the amount of power consumed.

(e) In still a further aspect, the storage battery control method further involves paying an incentive from the given consumer to the other consumer, the given consumer being a power borrower, when the given consumer has exceeded the threshold and the electric power has been supplied from the usable amount of power defined for the other consumer.

According to this configuration, the other consumers benefit from being able to receive an incentive, and consumers are able to borrow power from each other when necessary.

(f) In yet another aspect, at least one of the consumers is equipped with another-scale battery (i.e., the sub-battery 123), and the storage battery control method further comprises giving a discharge instruction to the other battery after the electric power has been supplied from the storage battery, when an additional judgement finds that a computed value also exceeds the first threshold, the computed value being a result of subtracting a supplied amount discharged from the storage battery from the total amount, and the given consumer is equipped with the other battery.

According to this configuration, when the consumer uses a large amount of power and discharge from the power cell does not bring the amount below a combined threshold, then another battery performs discharge to make up the rest. Accordingly, electricity fees are effectively reduced.

(g) In an additional aspect, at least one of the consumers is equipped with an HEMS (Home Energy Management System) executing control of electric appliances used by the consumers, and the storage battery control method further comprises making a control instruction to the HEMS for constraining power usage by the electric appliances after the electric power has been supplied from the storage battery, when an additional judgement finds that a computed value also exceeds the first threshold, the computed value being a result of subtracting a supplied amount discharged from the storage battery from the total amount, and the given consumer is equipped with the HEMS.

According to this configuration, when the consumer uses a large amount of power and discharge from the power cell does not bring the amount below a combined threshold, then power constraint control by the HEMS is used to make up the rest. Accordingly, electricity fees are effectively reduced.

(h) In another further aspect, the threshold is a second threshold (i.e., the power threshold 502) set individually and corresponding to a usable amount of power for each of the consumers, and the judgement is made regarding whether or not the amount of power used by each of the consumers exceeds the second threshold set therefor.

According to this configuration, a plurality of collective housing units share a common battery and achieve an effective reduction in electricity fees when each collective housing unit individually receives power though the high-voltage collective reception scheme.

In an alternative aspect, the storage battery control method further comprises acquiring a time from a clock used in detecting the amount of power; and acquiring a usable amount of power in the storage battery usable per unit time corresponding the time acquired from the clock, wherein the electric power is supplied from the storage battery to the power distribution system using the usable amount power in the storage battery usable per unit time as an upper limit.

According to this configuration, the battery does not operate in power cell units but rather in units of time set for a plurality of consumers to a similar effect, thus enabling a highly dynamic storage battery control method to be realised.

### INDUSTRIAL APPLICABILITY

The battery control system of the disclosure is applicable to an aggregator providing electric power supply, in a usage case where multiple households share a battery.

### REFERENCE SIGNS LIST

100 Aggregator
101 Consumed amount acquisition unit
102 Control unit
103 Judgement unit
104 Memory unit
105 Instruction unit
106 Power acquisition unit
110 Mega-battery
111 Control unit
112 Secondary cell
113 Discharge unit
114 Charge unit
120a, 120b, 120c Condominium
121 Smart meter group
122 Common controller
123 Sub-battery
124 HEMS
130 Power company
140 Bank
150 Power distribution system
160 Communication network
201 Power control table
202 Remaining power table
402a, 402b, 402c Power cell

1. A storage battery control method used by a control device controlling a storage battery prepared for a plurality of consumers, the storage battery control method comprising:
detecting an amount of power used by each of the consumers per unit time;
making a judgement regarding whether or not the amount of power used by one or more of the consumers exceeds a threshold determined in advance; and
when the amount of power used by the consumers exceeds the threshold, supplying electric power from the storage battery to a power distribution system to which the one or more consumers belong.

2. The storage battery control method of claim 1, wherein
the threshold is a first threshold set with respect to a total amount of power used by the consumers, and
the judgement is made regarding whether or not a total amount of power used by the consumers exceeds the first threshold.

3. The storage battery control method of claim 2, wherein
a usable amount of power in the storage battery usable per unit time is defined for each of the consumers,
when the judgement finds that the total amount exceeds the first threshold, a further judgement is made regarding whether or not the amount of power used by each of the consumers exceeds a second threshold corresponding to each of the consumers, and
the electric power is supplied to the power distribution system within a range indicated as the usable amount of power defined for a given consumer for which the further judgement finds that the amount of power used exceeds the second threshold corresponding thereto.

4. The storage battery control method of claim 3, wherein
an additional judgement is made regarding whether or not a computed value also exceeds the first threshold, the computed value being a result of subtracting a supplied amount discharged from the storage battery from the total amount, and
the electric power is supplied to the power distribution system from the usable amount of power defined for another consumer, after the additional judgement finds that the computed value exceeds the first threshold.

5. The storage battery control method of claim 4, further comprising
paying an incentive from the given consumer to the other consumer, the given consumer being a power borrower, when the given consumer has exceeded the threshold and the electric power has been supplied from the usable amount of power defined for the other consumer.

6. The storage battery control method of claim 3, wherein
at least one of the consumers is equipped with another battery, and
the storage battery control method further comprises giving a discharge instruction to the other battery after the electric power has been supplied from the storage battery, when an additional judgement finds that a computed value also exceeds the first threshold, the computed value being a result of subtracting a supplied amount discharged from the storage battery from the total amount, and the given consumer is equipped with the other battery.

7. The storage battery control method of claim 3, wherein
at least one of the consumers is equipped with an HEMS (Home Energy Management System) executing control of electric appliances used by the consumers, and
the storage battery control method further comprises making a control instruction to the HEMS for constraining power usage by the electric appliances after the electric power has been supplied from the storage battery, when an additional judgement finds that a computed value also exceeds the first threshold, the computed value being a result of subtracting a supplied amount discharged from the storage battery from the total amount, and the given consumer is equipped with the HEMS.

8. The storage battery control method of claim 1, wherein
the threshold is a second threshold set individually and corresponding to a usable amount of power for each of the consumers, and
the judgement is made regarding whether or not the amount of power used by each of the consumers exceeds the second threshold set therefor.

9. The storage battery control method of claim 8, wherein
a usable amount of power in the storage battery usable per unit time is defined for each of the consumers, and
the electric power is supplied to the power distribution system within a range of the usable amount of power defined for a given consumer for which the judgement finds that the amount of power used exceeds the second threshold corresponding thereto.

10. The storage battery control method of claim 9, wherein
a further judgement is made regarding whether or not a computed value also exceeds the second threshold, the computed value being a result of subtracting a supplied amount discharged from the storage battery from the amount of power used by the given consumer, and
the electric power is supplied to the power distribution system from the usable amount of power defined for another consumer after the electric power has been supplied from the storage battery and the further judgement finds that the computed value exceeds the second threshold.

11. The storage battery control method of claim 10, further comprising
paying an incentive from the given consumer to the other consumer, when the given consumer has exceeded the second threshold set therefor and the electric power has been supplied from the usable amount of power defined for the other consumer.

12. The storage battery control method of claim 8, wherein
at least one of the consumers is equipped with another battery, and
the storage battery control method further comprises making a discharge instruction to the other battery after the electric power has been discharged from the storage battery, when the further judgement finds that a computed value also exceeds the second threshold set for the given consumer, the computed value being a result of subtracting a supplied amount supplied from the storage battery from the total amount, and the given consumer is equipped with the other battery.

13. The storage battery control method of claim 8, wherein
at least one of the consumers is equipped with an HEMS (Home Energy Management System) executing control of electric appliances used by the consumers, and
the storage battery control method further comprises making a control instruction to the HEMS for constraining power usage by the electric appliances after the electric power has been discharged from the storage battery, when the further judgement finds that a computed value also exceeds the second threshold set for the given consumer, the computed value being a result of subtracting a supplied amount supplied from the storage battery from the total amount, and the given consumer is equipped with the HEMS.

14. The storage battery control method of claim 1, further comprising:
acquiring a time from a clock used in detecting the amount of power; and
acquiring a usable amount of power in the storage battery usable per unit time corresponding the time acquired from the clock, wherein
the electric power is supplied from the storage battery to the power distribution system using the usable amount power in the storage battery usable per unit time as an upper limit.

15. A storage battery control system controlling a storage battery prepared for a plurality of consumers, the storage battery control system comprising:
a detection unit detecting an amount of power used by each of the consumers per unit time;
a judgement unit making a judgement regarding whether or not the amount of power used by one or more of the consumers exceeds a threshold determined in advance; and
a supply unit supplying electric power from the storage battery to a power distribution system to which the consumers belong, when the amount of power used by the consumers exceeds the threshold.
